(19) United States
(12) Patent Application Publication
(10) Pub. No.: US 2004/0068899 A1
(43) Pub. Date: Apr. 15, 2004

(54) Foldable reservation sign for coin operated machine

(76) Inventor: Timothy O. Hart, Downers Grove, IL (US)

Correspondence Address: JAMES N VIDEBECK, 1 S 376 SUMMIT AVE, COURT C, OAKBROOK TERRACE, IL, 60181, US

(21) Appl. No.: 10/353,321

(22) Filed: Jan. 30, 2003

Related U.S. Application Data
(63) Continuation-in-part of application No. 10/266,262, filed on Oct. 9, 2002.

(51) Int. Cl. G09F 1/00; G09F 7/00

(52) U.S. Cl. 40/124.09; 40/606.03

(57) ABSTRACT

A sign for indicating the temporary reservation of a coin operated apparatus including a coin slot for receiving a coin includes a first sheet-type display and a tab sized for insertion in a coin slot that depends from the display and is hingedly attached to it. The sign may also include additional display sheets hingedly connected to the first sheet-type display to enlarge the total display area. The sign includes a pocket for receiving a transaction or comp card and a tether to keep the card and sign together. The sign folds up to approximate the footprint of a transaction card and fit into the pocket or wallet of a user.

This is a continuation-in-part application of Ser. No. 10/266,262, filed Oct. 9, 2002.

This invention relates to an information sign for use in connection with a coin operated machine, and more particularly, to a foldable reservation sign for use in such a machine that may be tethered to a computer readable tracking card.

### BACKGROUND OF THE INVENTION

Coin operated machines serve a multitude of purposes. Aside from delivering products to us in vending-type machines, arcade game and other game machines provide substantial entertainment to users of coin operated machines. In many of the game-type coin operated machines, a user or player of the game obtains certain advantages after being at the coin operated machine for a period of time, whether an accumulation of points an accumulation of free games, or other benefits that may accrue to a user. If a user wishes or needs to temporarily leave his or her position at the coin operated machine, that user may want to reserve that machine for his or her future use while being away from the machine for a short time. While these coin operated machines, highly electronic in nature, could be set up by the manufacturer to reserve the machine for a specified user, the builders and owners of such machines would rather the machine be in constant use or play. Therefore, while the coin operated machine shown in U.S. Pat. No. 6,120,031 shows the ability to reserve a wild card indicia from one game to another, there is no provision in that patent for electronically reserving the use of that machine to a certain predetermined individual user.

For coin operated machine owners, lessees, management or service personnel, provisions have been made for carrying relatively large signs when they need to indicate that a coin operated machine is out of order, or at least should be out of use. U.S. Pat. No. 4,367,605 shows such a sign for a coin operated machine that is insertable in the coin slot and includes a retaining wire that must be manipulated to remove the sign from the coin slot. While the size of the upper portion of the sign in the above identified patent is indicated as being about 3½ inches by 1¾ inches, the addition to the upper portion of the sign of a guide member or tab that extends approximately 2 inches from the sign increases its overall size to make it inconvenient for carrying in the pocket or wallet of management or service personnel, especially with the addition of the wire legs to the sign.

Further, since about 1998, owners of entertainment establishments have designed and implemented customer tracking and recognition programs that are activated when the facility receives customer data from input devices such as transaction card readers, electronically connected to the coin operated machines. These customers are awarded points that are redeemable for gifts, meals, cash and the like at any of the coin operated machine owner's properties. These programs are described in U.S. Pat. No. 5,761,647.

In order to take advantage of these promotional programs, coin operated card users must carry a tracking card, similar to a credit card and insert them into machines while the machines are being used. While these cards are sized as traditional credit cards and may be carried in the pocket or wallet of a user, users still have no ready transportable means for reserving a machine they are using if they need to temporarily leave the location of the machine.

A need has developed for a readily transportable means for reserving one's position as a user of a coin operated machine when one temporarily leaves the machine's location. Additionally, a need has developed for providing readily transportable signage for a coin operated machine user to temporarily reserve a machine for play when that user is absent from the machine location that may be utilized in connection with a customer tracking and recognition program card.

Accordingly, it is an object of the present invention, generally stated, to provide a portable signage usable to reserve a coin operated machine that may be folded to approximate the footprint size of a pocket-type carrier for a tracking or transaction card.

### SUMMARY OF THE INVENTION

The invention resides in a sign for indicating the temporary reservation of a coin operated apparatus including a coin slot for receiving a coin. The sign comprises a sheet type display means for displaying communication thereon approximating the size of a transaction card. Tab means extending from an edge of the display means, and the tab means being sized for insertion in a coin slot of a coin operated apparatus, and a living hinge joining the tab means and the display means.

### BRIEF DESCRIPTION OF THE DRAWINGS

The features of the present invention which are believed to be novel are set forth with particularity in the appended claims. The invention may best be understood by reference to the following description taken in conjunction with the accompanying drawings, in which like numerals refer to like parts, and in which:

FIG. 1 is a perspective view of a coin operated machine having a sign constructed in accordance with the present invention positioned thereon;

FIG. 2 is a top plan view of a blank of a first embodiment of the present invention;

FIG. 3 is a perspective view of the first embodiment of the present invention shown in semi-folded position;

FIG. 4 is a top plan view of a blank of a second embodiment of the present invention;

FIG. 5 is a top plan view of the second embodiment of the invention showing the pocket formed therein;

FIG. 6 is a perspective view of the second embodiment of the present invention shown in semi-folded position;

FIG. 7 is a top plan view of a blank of a third embodiment of the present invention together with an additional piece to be adhered to the blank to form a pocket therein;

FIG. 8a is a top plan view of the blank shown in FIG. 7 having the additional piece adhered thereto to form a pocket therein;

FIG. 8b is a cross sectional view taken substantially along line 8b-8b of FIG. 8a; and

FIG. 9 is a perspective view of the third embodiment of the present application shown in semi-folded position.

### DETAILED DESCRIPTION OF THE PREFERRED EMBODIMENT

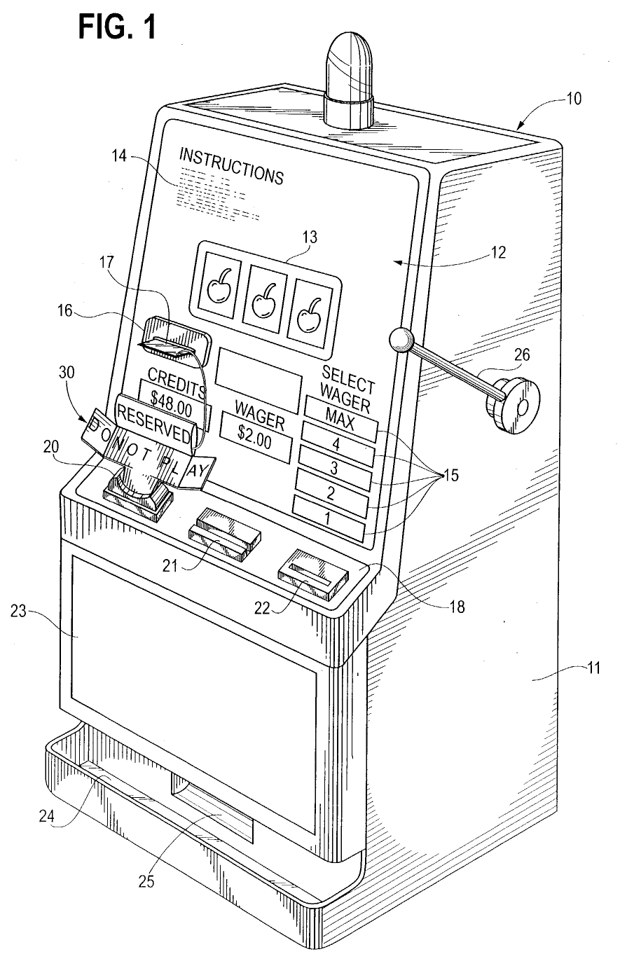

Referring to FIG. 1, a coin operated machine, generally indicated at 10, constructed in accordance with the present invention includes an outer shell or cover 11 covering a plurality of electronic circuitry, not shown, which operates the machine. Adjacent the top front of outer cover 11 is a front display portion, generally indicated at 12, that includes a game electronic display 13, a set of instructions 14 for operating the machine or the game, and a plurality of additional displays 15 that may take any form the game producer desires. Below and to the left of the game display 13 is a transaction or comp card holder 16 that receives the tracking card identified in U.S. Pat. No. 5,761,647, commonly referred to as a tracking card. The tracking card is shown at 17, partially inserted therein.

At the bottom of display portion 12 projects a ledge 18 that includes money handling apparatus for the coin operated machine. At the left side is a coin slot 20. In the center is a credit or debit transaction card slide 21, and at the right side at 22 is a bill receiving slot.

Below the projecting ledge 18 is a lower display area 23 that may have any desired indicia thereon. Adjacent the bottom of the coin operated machine is a coin reservoir 24 and a coin slot 25 from which coins, tokens or other prizes may be awarded from the machine. At the right side of cover 11 is a lever arm 26 that may be pulled to start each game or transaction.

At the left end of ledge projection 18 and inserted in the coin slot 20 is a first embodiment of the reservation sign of the present invention, generally indicated at 30. In the first embodiment 30 of the present invention, the reservation sign 30 is connected by a tether 31 to the transaction card 17 mounted in the transaction card slot 16.

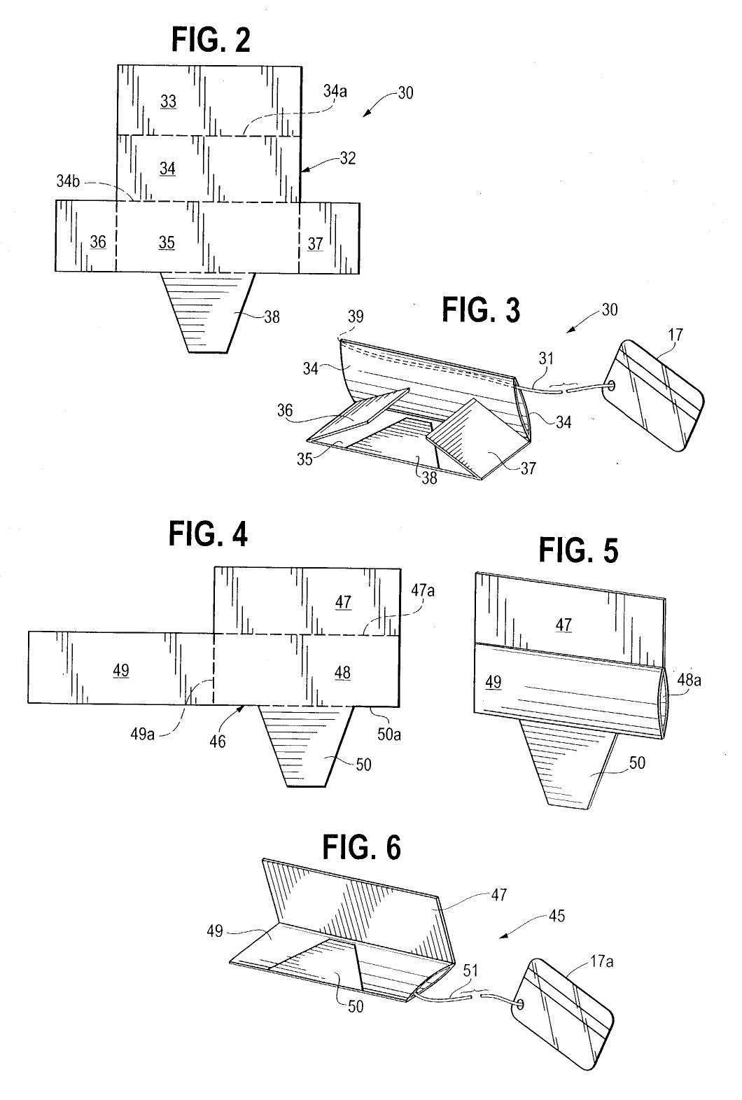

Referring to FIG. 2, a blank cutout 32 of the first embodiment of the sign 30 of the invention includes three like shape rectangles 33, 34 and 35 positioned serially in vertical relation to each other. The rectangles may preferably be sized approximately 3¾ inches by 2 inches each. Adjacent the bottom of serial rectangle 35, opposing extensions 36, 37 extend from the ends of rectangle 35 and are approximately 1½ inch wide by 2 inches high each. Extending from the base of rectangle 35 is a tongue or tab 36 which approximates 2 inches at its base, and extends approximately 2 inches from the bottom of base rectangle 35. Tab 36 may be trapezoidal in shape with its distal end approximating ¾ inch in width. The bottom may be rounded if desired. Tab 36 may be any convenient shape that will fit in a coin slot such as shown at 20.

As shown most clearly in FIG. 1, the top rectangle 33 in the first embodiment is folded along crease 33a and sealed along a seam 34a and 34b to form a pocket having an opening at 34c in which the transaction or tracking card 17 may be received and kept. As shown most clearly in FIG. 3, the entire sign may be folded with extensions 36, 37 and tab 38 folded inwardly onto the bottom rectangle 35 and the pocket composed of rectangles 34 and 33 folded thereover to approximate a footprint which is only slightly larger than the size of the transaction card 17 which is then easily inserted into pockets 34c, all to fit within a pocket or a wallet of a user.

When the sign of the invention as shown in FIG. 1 is displayed, the integration feature of the tethered transaction card together with the unfolded sign, especially when the transaction card is inserted in the slot 16 of the coin operated machine provides a more formidable display than simply the sign itself. When the transaction card 17 is inserted into the pocket 34c, the tether 31 may be rather easily put into the pocket also. In this embodiment, the tether 31 extends through the entire length of the pocket 34c and is fastened at the bottom end thereof at 39.

In the preferred embodiment, the sign 30 may be made of a polyvinyl material, polyethylene, polypropylene or the like. It would also be preferable to use a material that has a “memory” so it will tend to spread out when open even after it has been closed or folded for a substantial period of time. As long as tab 38 fits into a coin slot, it may be desirable to have a fastener or adhesive mounted on one side (an underside as folded) mounted on it. The tab may then be folded outside of the pocket and be selectably releasably retained thereon, perhaps by a hook and loop fastener.

Referring to FIGS. 4, 5 and 6, a second embodiment of the present invention is generally indicated at 45. The blank for the second embodiment, shown generally at 46 in FIG. 4, includes a top rectangle 47, a bottom rectangle 48 and a left hand rectangle 49. These three rectangular portions together with tab 50 extending from the bottom of the bottom rectangle 48, provides a blank for proper folding in a manner somewhat different than that of the first embodiment 30. With the second embodiment 45, the left hand rectangle 49 is folded along its right edge 49a onto the top of the bottom rectangle 48 and sealed thereto along edges 47a, 49a and 50a to provide a pocket having an opening 48a shown most clearly in FIG. 5. While the second embodiment 45 is not quite as big as the first embodiment 30 in sign surface, it only needs to be folded along lines 47a and 50a as shown in FIG. 6 to close the sign to a size slightly larger than the transaction card 17a together with its the tether 51. The second embodiment would provide a more economical sign to make and simplify the folding process. As with the first embodiment, a hook and loop fastener, commonly sold under the mark VELCRO, could be utilized in connection with the outer surface of upper rectangle 47 and the inner surface of the tab 50 to secure the folded sidewalls of the sign together with the tab 50 being positioned over the folded upper rectangle 47 when the entire assembly is in folded position.

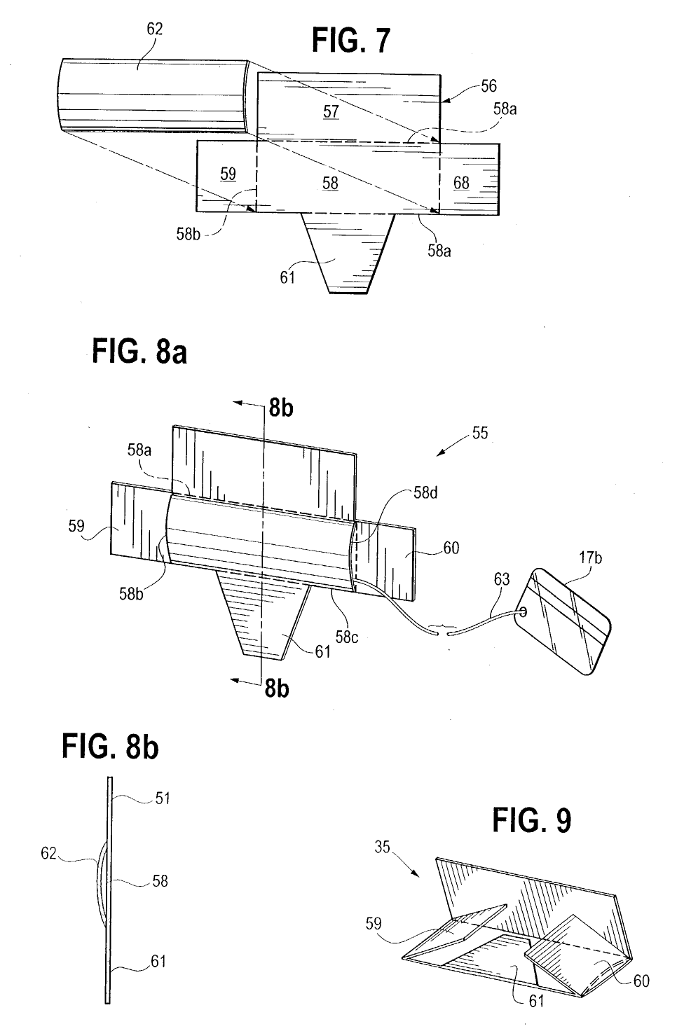

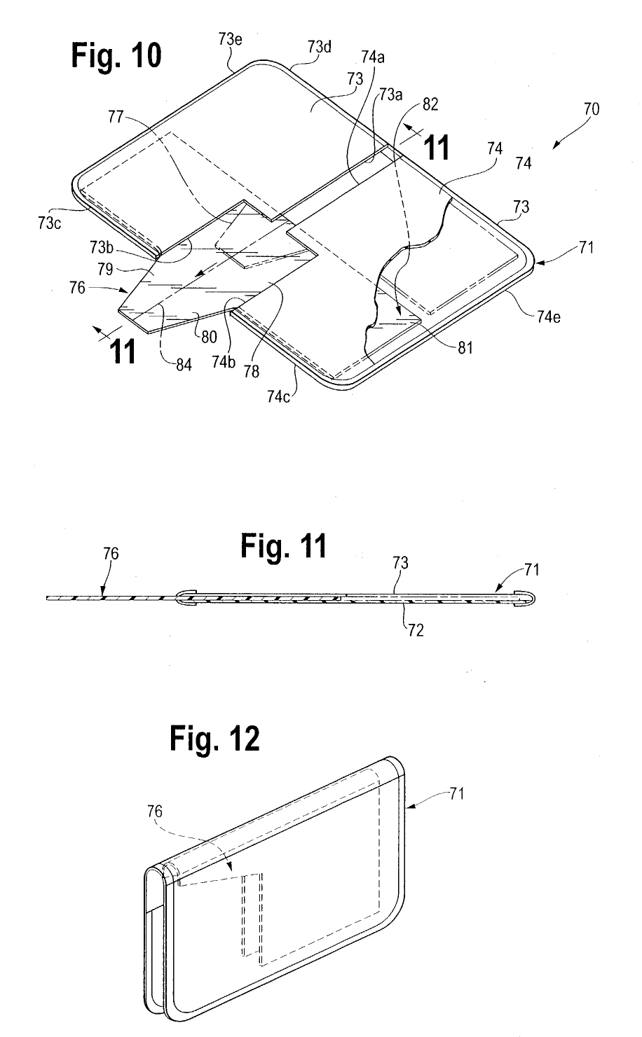

Referring to FIGS. 7-9, a third embodiment of the present invention, generally indicated at 55 in FIG. 7, a blank for the third embodiment, is identified at 56 and includes a top rectangle 57 a bottom rectangle 58, left and right extensions 59, 60 and tab 61, all similar to the first embodiment without the third rectangle thereof. In the third embodiment 56 of the invention, the top rectangle of the first embodiment 30 is supplanted by a separate rectangle 62 that is positioned over the bottom rectangle 58 and sealed along three of its edges to bottom rectangle 58 adjacent folding lines 58a, 58b and 58c to form a pocket having an opening 58d into which the transaction card 17b of the invention may be inserted along with its tether 63. As shown most clearly in FIG. 8b, the joinder of the edges of the rectangle 62 to the edges of rectangle 58 may be by heat sealing, adhesive gluing or other appropriate adhering means. As shown most clearly in FIG. 9, the third embodiment 55 of the invention is similar to the first embodiment 30 of the invention with the exception that the pocket has been moved from the upper portion of the sign to the middle portion of the sign. The end extensions 59 and 60 fold similarly to the end extensions 36 and 37 in the first embodiment, and tab 61 folds similarly to the tab 38 of the first embodiment.

Referring to FIGS. 10-12, a fourth embodiment of the present invention, generally indicated at 70 in FIG. 10, includes a blank or housing 71 that may be a modification of a plastic business card holder or bank check holder. Housing 71 includes a generally rectangular back side 72 formed of a plastic sheet, vinyl or the like, and a pair of opposed front sheets 73, 74 (FIG. 10) that are slightly less than half the width of back side sheet 72. Front sheets 73, 74 are, in the preferred embodiment, heat sealed or otherwise adhered to the back sheet 72 along three sides of their perimeters where each of the respective two ends 73c, 73d, 74c, 74d and outer side of the sheets 73e, 74e conform to the periphery of back side sheet 72. As shown in FIGS. 10 and 16 in inner edge 73a, 74a is open (unfastened to bottom sheet 72) to define a pair of hollow pockets, one each between the top sheets 73, 74 and bottom sheet 72. As shown most clearly in FIG. 10, a pair of complementary cutout sections 73b, 74b are positioned with section 73b between sides 73a and end 73c and section 74b positioned between side 74a and end 74c on the housing 71. In the preferred embodiment 70 of the present invention, the front sheets 73, 74 are made of the same plastic, vinyl or the like material as is the back side sheet 72. This plastic material will be colored to present a generally flat surface on which indicia may be printed or otherwise positioned to indicate that the machine on which the sign is positioned is being reserved for a person who is temporarily absent. Advertising, promotional materials, logos, and the like may also be printed, embossed or otherwise positioned on the flat surfaces.

A slide, generally indicated at 76, preferably made of a plastic material that is less flexible than the material of the blank or housing 71 fits within the two hollow pockets between front sheets 73 and 74 and the back sheet 72. Slide 76 includes a bifurcated rectangular portion indicated at 77, 78 and a bifurcated depending tab indicated at 79 and 80 that is sized to protrude from the space denoted by notches 73b, 74b and the end or bottom 73c, 74c of the housing 71. A spine or living hinge 84 divides the slide into two halves. When the slide is pushed upwardly in the pockets, the tab 79, 80 withdraws inside the periphery of the fourth embodiment 70. When the slide is moved downwardly in the pockets, the tab 79, 80 extends from the bottom 73c, 74c of the fourth embodiment to provide a tab similar to that shown in the previous embodiments that may be fitted within a coin slot of a coin operated machine.

In this embodiment, an aperture 81 in bifurcated rectangle half 78 of slide 76 provides a means for mounting a tether 82 thereto which, in turn, is mounted to a comp card (not shown) similarly to the prior embodiments shown and described above. The comp card may be positioned within one of the aforesaid pockets when it is not being inserted into a coin operated machine as is shown with the first embodiment of FIG. 1.

Referring to FIG. 12, when the slide 76 is retracted into the housing 71, the living hinge 84 that bifurcates the slide 76 may be folded along with the remainder of the housing 71 along the middle or spine of the back side to provide a thin folded sign that may be positioned in the pocket, or wallet of a user while also maintaining a hollow pocket for the comp card.

Thus, an economical, efficient sign has been shown and described which can be displayed by the user of a coin operated machine to reserve that machine temporarily in his or her absence. The sign incorporates a pocket which may be utilized to receive and retain a tracking card therein.

While four differing embodiments of the present invention have been shown and described, it will be apparent to those skilled in the art that many changes and modifications may be made without departing from the true spirit and scope of the present invention. It is the intent of the appended claims to cover all such changes and modifications which fall within the true spirit and scope of the invention.

What is claimed:

1. A sign for indicating the temporary reservation of a coin-operated apparatus including a coin slot for receiving a coin, said sign comprising:
sheet type display means for displaying a communication thereon approximating the size of a transaction card, tab means extending from an edge of said display means,
said tab means being sized for insertion in a coin slot of a coin operated apparatus, and a living hinge joining said tab means and said display means.

2. The sign as defined in claim 1 wherein said living hinge provides for back folding said tab means to said display means with said tab means being sized to fit within a perimeter of said display means when back folded thereagainst.

3. The sign as defined in claim 1 wherein said display means includes a hollow pocket having a front side and a back side, each larger in width and height than a transaction card, joined together around at least a portion of the peripheries of each to form a hollow area therebetween suitable for the insertion and releasable retention of a transaction card therein.

4. The sign as defined in claim 1 further including a tether affixed thereto, said tether having a length longer than a straight line distance between a coin slot and a transaction card slot on any machine and which said sign is adapted to be used.

5. The sign as defined in claim 1 wherein said display means is a rectangular first display means, and said sign further includes:
sheet type second display means extending from an edge of said first display means other than said edge said tab means is extending from.

6. The sign as defined in claim 5 wherein said second display means includes a pair of mirror image shape sheets or panels positioned to extend from opposing edges of said first display means.

7. The sign as defined in claim 5 wherein said sheet like second display means is articulately connected to said first display means.

8. A sleeve for a transaction card, said sleeve comprising:
a front sheet and a back sheet, said sheets connected around a substantial portion of at least one of said sheets and not connected along an end of at least one of said sheets defining an opening sized for insertion of a transaction card therein,
said sleeve including tab means extensible therefrom sized for insertion and selectable retention in a coin slot of a coin operated apparatus.

9. The sleeve as defined in claim 8, wherein said back sheet is larger than said front sheet and said tab means is on said back sheet.

10. The sleeve as defined in claim 9 wherein said back sheet includes a pair of panels extending from opposed ends of a rectangular central portion of said back sheet, a living hinge defining a border between each of said panels and said central portion providing for folding each of said panels over said central portion when said sleeve is in storage.

11. The sleeve according to claim 9 wherein said back sheet includes a panel extending from an end of a rectangular central portion of said back sheet opposing an end that includes said tab means.

12. The sleeve according to claim 8 further including tether affixed thereto at one end of attaching a transaction card to an opposing end thereof.

13. The sleeve as defined in claim 10 wherein said pair of panels are mirror images of each other.

14. A blank for forming a reservation sign for use on a coin-operated machine, said blank comprising:
a rectangular bottom panel with each of said top, bottom and opposing ends being larger than corresponding sides of a transaction card,
a tab about 2 inches long depending from said bottom of said bottom panel sized to fit into a coin slot of a coin operated machine, said tab being hingedly connected to said bottom of said bottom panel.

15. The blank as defined in claim 14 further including,
a rectangular upper panel similarly sized to said rectangular bottom panel, a bottom of said upper panel being hingedly connected to said top of said bottom rectangular panel.

16. The blank as defined in claim 14 further including,
a rectangular side panel similarly sized to said rectangular bottom panel, an end of said side panel being hingedly connected to an end of said rectangular bottom panel.

17. The blank as defined in claim 15 further including,
a rectangular top panel similarly sized to said rectangular upper panel, a bottom of said top panel being hingedly connected to said top of said upper rectangular panel.

18. The blank as defined in claim 15 further including,
a second blank sized similarly to said bottom rectangular panel for attachment to said rectangular bottom panel along an end and top and bottom thereof.

19. A sign for indicating the temporary reservation of a coin-operated apparatus including a coin slot for receiving a coin, said sign comprising:
display means including a foldable housing for displaying a communication thereon, tab means positioned on said housing and extensible from an edge of said display means, and
said tab means being sized for insertion in a coin slot of a coin operated apparatus as extended from said display means.

20. The sign as defined in claim 19 wherein said foldable housing includes at least one hollow pocket therein.

21. The sign as defined in claim 20 wherein said tab means being slidably received in said hollow pocket.

22. The sign as defined in claim 19 wherein said tab means is foldable along a central spine thereof.

23. The sign as defined in claim 19 wherein said housing includes a generally rectangular back sheet foldable along a center spine thereof, a pair of generally rectangular front sheets, each having an area less than half of said back sheet and each being peripherally and spatially retained on said back sheet with said space therebetween identifying a foldable spine of said back sheet and defining a pair of opposed pockets, one between each of said front sheets and said back sheet.

24. The sign as defined in claim 23 wherein said tab means includes a body portion and a tab extending from a side of said body portion, said body portion and said tab including a coaxial foldable spine defining a pair of body halves and a pair of spine halves, and said each of said body halves being slidably retained in one of said pair of opposed pockets.
